(19) United States
(12) Patent Application Publication
(10) Pub. No.: US 2001/0013283 A1
(43) Pub. Date: Aug. 16, 2001

(54) Device and method for printing of traffic signs

(76) Inventors: Albert Pfundstein, Siegen (DE); Martin Ziegler, Karlsruhe (DE); HUbert Sussner, Oberasbach (DE)

Correspondence Address: AKERMAN SENTERFITT, Esperante Building, Suite 400, 222 Lakeview Avenue, Post Office Box 3188, West Palm Beach, FL, 33402-3188, US

(21) Appl. No.: 09/741,757

(22) Filed: Dec. 19, 2000

(30) Foreign Application Priority Data
Apr. 19, 1999 (DE) 199 17 638.8
Apr. 17, 2000 (DE) PCT/DEOO/01206
Mar. 23, 2000 (DE) 100 14 558.2

(51) Int. Cl. B41F 17/00

(52) U.S. Cl. 101/35; 400/120.01

(57) ABSTRACT

A method for printing on traffic signs, comprising the following process sections: storage of a pattern in digitized form of a traffic sign to be created by means of a reading device and transmission of said pattern to a printer; printing the stored pattern on a hot stamping foil by means of a printer, preferably in a mirror-inverted way on the surface of the hot stamping foil coated with a hot-melt adhesive; conveyance of the printed hot stamping foil to a laminating device by means of a foil guide, and heat laminating of the printed hot stamping foil to a reflecting sheet, which is preferably laminated to the front side of a sign blank, by means of the laminating device, heat laminating preferably being performed by means of heated stamps or heated stamp rolls either on a point or over a surface.

### BACKGROUND OF THE INVENTION

The subject matter of the present invention is a novel method for printing of traffic signs and a device hereto.

Large-format traffic signs, specifically signposts, consist of a sign blank made of aluminum on the front side of which the content of the sign, such as traffic advice, information about distances or warnings of hazardous conditions, is inscribed. The body of the sign is made of aluminum plates which are joined together by means of connecting profiles and reinforced by reinforcing strips riveted to the backside of the sign. Generally, the back of the sign is painted in grey. A retroreflecting sheet is laminated to the front side of the sign and performs the function of reflecting the impinging headlight by night. The actual content of the sign such as directional, regulatory or warning information is inscribed on this retroreflecting sheet.

Two methods are available for inscribing the content of the sign. Those traffic signs that are manufactured on a large scale are printed on using the technique of screen printing. Since large traffic signs, signposts in particular, often constitute one individual specimen, the cost for making a stencil for screen printing is too high. Therefore, traffic signs of this type are printed on using an alternative method.

On a computer-aided design workstation, a pattern for the traffic sign is designed. With the aid of this pattern, the required symbols, such as letters, numbers or arrows, are cut or sheared out of a suitably inked laminated foil, which is self-adhesive on its rear side. This action is often conducted in plotting centers that have been established to serve this special purpose.

With the help of the pattern the contours of the symbols are transferred to the front side of the sign that has been coated with a reflecting sheet. This is performed in a classical way by an experienced designer who reproduces manually the symbols with pencil and foot-rule. In a more modern method, the contours are transferred to the front side of the sign by means of large graphics plotters.

In the following working step the symbols that have been sheared out are positioned along the contours on the front side of the sign. Then, a so-called reproduction sheet is calendered thereto, said reproduction sheet being laminated on its rear side to be self-adhesive. This reproduction sheet maintains the symbols to be stuck in their relative position. Subsequently, the reproduction sheet is pulled off again together with the symbols which stick on it, i.e., which are disposed in their definitive relative arrangement. In the following step, the protection sheets are removed from the rear sides of the symbols to be stuck. The reproduction sheets together with the symbols that stick on it and that are to be transferred are adjusted over the traffic sign to be printed on and calendered again. In this step the symbols to be stuck are bonded to the traffic sign. In the last working step the reproduction sheet and the lines serving for the orientation of the symbols are removed.

This method requires skilled staff that has to accomplish a plurality of working steps by hand. This has the major share in the manufacturing costs of signs.

DE 43 27 995 discloses a method for applying a variable designation onto a substrate. In a first embodiment, a variable designation is transferred with this method from a heated transfer foil to a substrate and then, in a subsequent process section, said designation is stamped by means of a hot stamping foil. In a second embodiment the variable designation is transferred to the heat-sealing layer of a hot stamping foil by means of a heat transfer printer. By means of conventional hot stamping procedures this hot stamping foil is transferred, together with the variable designation inscribed thereon, to a substrate.

### SUMMARY OF THE PRESENT INVENTION

It is an object of the present invention to indicate a method for manufacturing traffic signs that provides the possibility to manufacture large-surface traffic signs with a considerably reduced need for work and staff over the prior art methods and to indicate a device hereto as well.

The solution of this object is achieved by a method according to claim 1 and by a device according to claim 7.

A pattern is created for a traffic sign, said pattern preferably being submitted in digitized form. Said pattern is stored by means of a reading device and is transmitted to a printer. Said printer prints the memorized pattern on the hot stamping foil. Printing preferably occurs mirror-inverted on the surface of the hot stamping foil coated with a hot-melt adhesive. The imprinted hot stamping foil is conveyed to a laminating device by means of which the imprinted hot stamping foil is laminated in a heat laminating process to a reflecting sheet which preferably is laminated to the front side of the sign blank. Heat laminating is preferably performed by means of heated stamp dies or heated stamp rolls and may be carried out at one point or over a surface.

The device in accordance with the invention comprises the elements required for carrying out the inventive method.

To print the design on the hot stamping foil, all types of printers that are suitable for printing on a hot stamping foil, and that are more particularly suitable for printing on the surface coated with hot-melt adhesive of said hot stamping foil may be used. The methods that are particularly designed to fit the purpose are the techniques used in heat transfer printing. However, electrostatic printing methods or ink jet printing methods are suitable as well. The impression may include colored and/or black-and-white elements, irrespective of the printing technique employed.

The method for printing on traffic signs according to the invention has many advantages over the heretofore known methods for applying contents of signs to traffic signs. Within the scope of these prior art methods, electronic patterns were often created by means of which the contents of the signs were cut or sheared out of a foil. Accordingly, said pattern could be used to generate individual elements of the image to be represented. The arrangement of these individual elements of the image on a sign blank coated with a reflecting sheet had to be carried out in subsequent process sections, though. By contrast, the novel method allows a plurality of individual elements of the content of the sign to be transferred to a hot stamping foil in their correct relative position and permits to subsequently transfer this imprinted hot stamping foil to a large surface of the sign blank to be imprinted. In this way, the irksome relative arrangement by hand of the individual elements of the content of the sign on the sign blank is no longer necessary. In particular the need for the labor-intense reproduction of the pattern's contours onto the blank to be printed on by specifically skilled staff is eliminated.

Furthermore, the method according to the invention has the advantage that the new traffic sign is absolutely equal to the pattern. This was not always the case with the prior art devices.

Additionally, laminating the imprinted hot stamping foil to the sign blank coated with a reflecting sheet does not have to be carried out at the same location at which the hot stamping foil has been imprinted. More specifically, the method according to the invention permits to apply the content of the signs onto the traffic signs only in close proximity to the place where they are to be erected. This is possible, provided that a laminating device is available in the neighborhood of the place of erection of the traffic sign. Since however such laminating devices are relatively simple, technically not very complicated machines, they possibly may be available worldwide. The enormous advantage thereof is that the technically more complicated production of a hot stamping foil imprinted with the content of the sign may be accomplished in a printing center technically suitably equipped from which the imprinted hot stamping foil may be brought to the future place of erection of the traffic sign, preferably in a rolled up condition. This is more specifically possible all over the world.

More specifically, the method according to the invention has the advantage that the contents of the signs that have to be applied are stamped over with a transparent protective lacquer layer, the hot-melt adhesive layer. This transparent sheet may be fitted with further useful properties such as an antidew or an antigraffiti coating or it may be provided with UV-absorbing additives. In this case, the transparent protective lacquer layer protects the content of the sign lying underneath and the reflecting sheet from premature aging, from fading due to intensive insulation for example. It also protects from weathering due to humidity.

Another advantage of the method according to the invention is that all kinds of reflecting sheets are suitable for being laminated to the sign blank. This constitutes an enormous advantage over a method in which the reflecting sheet is imprinted directly, since only few kinds of reflecting sheets may be printed on directly. In this way, the manufacturer of the signs does not depend on the availability of specific reflecting sheets and above all on a few suppliers. More specifically, the most various national regulations regarding the reflection background of the traffic sign may thus be taken into account.

Further characteristics and advantages of the method in accordance with the invention and of the device in accordance with the invention will become apparent in the following embodiments that are not to be in any way limiting and that are explained by way of example with the help of the drawings in which:

### BRIEF DESCRIPTION OF THE DRAWINGS

FIG. 1: is a side view of a device according to the invention,

FIG. 2: is a top view of a device according to the invention,

FIG. 3: is a detailed side view of a laminating device and

FIG. 4: is a section through a multilayer laminate.

### DETAILED DESCRIPTION OF THE INVENTION

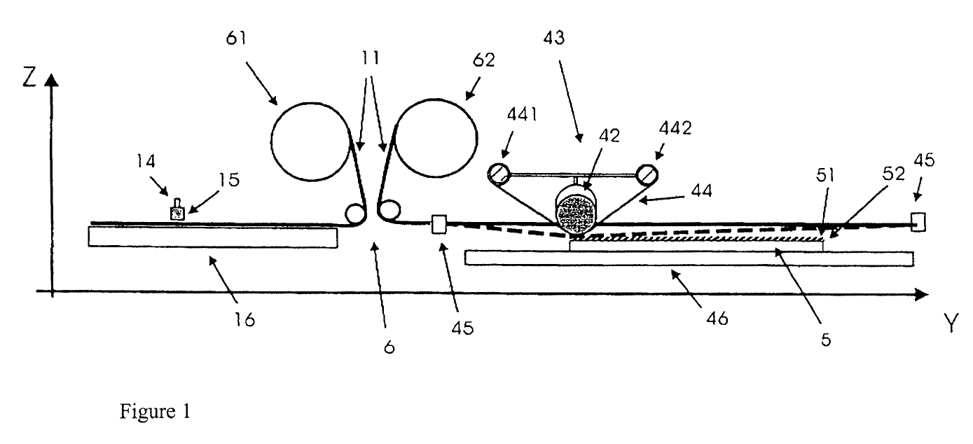

FIG. 1 shows a device according to the invention that uses a heat transfer printing system for printing on the heat-sealing film. A computer-aided reading device 2 is linked to the control 13 of the heat transfer printer 1. The guide 14 of the print head 15 is also shown, said guide permitting to print on the hot stamping foil 11 (see DE 43 27 995 C2 incorporated herein by reference) along the full width thereof. Printing is preferably carried out on the side of the hot stamping foil 11 which is coated with hot-melt adhesive 12. During the process of printing, the hot stamping foil 11 is laid on a printing table 16. Upon completion of the printing process, the imprinted hot stamping foil 11 is led to the laminating device 4. The foil guide 6 employed to this purpose is not shown in detail. In the simplest case, that is when the laminating process immediately follows the printing process, and when printer 1 and laminating device 4 are closely adjacent, said foil guide may consist of simple elements, like guiding plates or rolls, which guide the imprinted hot stamping foil 11. The guiding elements may more specifically be integrated in the printer and/or in the laminating device 4.

In an advantageous development, the foil guide 6 consists of a first portion 61 arranged in close proximity to the printer 1. Said first portion 61 permits to roll up the imprinted hot stamping foil 11 so that it becomes ready for conveyance. In this case, the second portion 62 of the foil guide 6 will consist of an unrolling device for the rolled up imprinted hot stamping foil 11.

The laminating device 4 is provided with a table 46 on which the sign blank 5 with the reflecting sheet 51 laminated on its front side is laid. The table defines an X-Y-plane, the Y-axis being determined by the machine direction of the hot stamping foil 11. A heated stamp roll 42 which extends over the overall width (X-axis) of the table 46 is arranged above said table. For this stamping procedure, said heated stamp roll 42 is heated to a temperature ranging from 170° to 200°, the actual temperature being determined by the properties of the hot-melt adhesive 12 employed. The height at which the heated stamp roll 42 is placed above the table 46 may vary. Said heated stamp roll 42 is arranged so as to be slidable in direction of the Y-axis of FIG. 1. The motion in Y-direction may in particular be motor-driven.

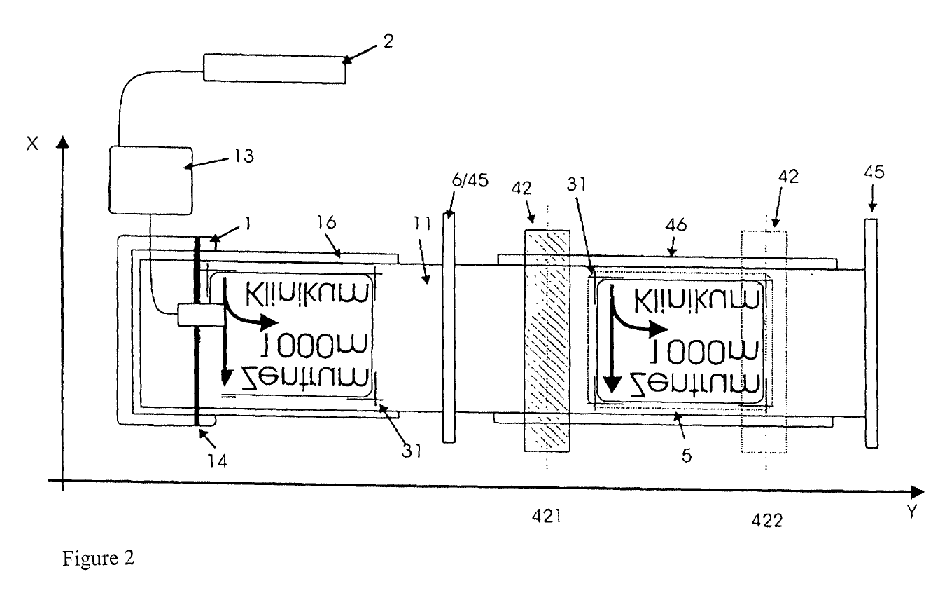

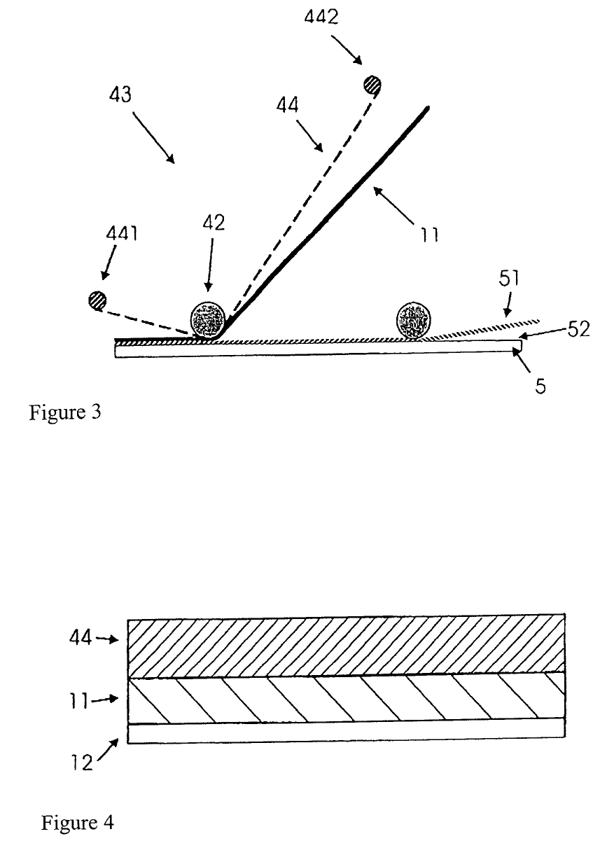

FIG. 2 shows the same device in a top view illustration. For the sake of clarity, a width of hot stamping foil 11 which has already been imprinted with the content of a sign is shown. Stated somewhat more specifically, a heat transfer printer is shown in the process of printing, as well as an area of the hot stamping foil 11 positioned above the table 46 which is already imprinted with the content of a sign.

The method according to the invention is carried out by means of the device illustrated in the following manner: the pattern 3 of a traffic sign to be created, which has been submitted in digitized form, is stored by means of a computer-aided reading device 2 and is transmitted for printing to a heat transfer printer 1. Said heat transfer printer. 1 prints the memorized pattern 3 on the hot stamping foil 11 placed on the printing table 6. This preferably occurs mirror-inverted on the surface of the hot stamping foil 11 coated with hot-melt adhesive 12.

The hot stamping foil 11 printed with the content of the sign is fed to the laminating device 4 by way of a foil guide 6 in such a manner that the hot-melt adhesive layer 12 faces the upper side of the sign blank 5. In the device herein illustrated and prior to the laminating process, the imprinted hot stamping foil 11 is completely stretched over the sign blank 5 that has to be provided with the content of the sign by means of a stretching device, i.e., the imprinted area of the hot stamping foil 11 accurately covers the sign blank 5 to be coated. In order to render fitting of the printed hot stamping foil 11 over the sign blank 5 to be coated more easy, further orientation aids 31 may be printed on the hot stamping foil 11 in addition to the content of the sign in the process of printing. Thanks to said orientation aids 31 the positioning of the sign blank 5 relative to the printed area of the hot stamping foil 11 is facilitated. The relative positioning may be performed by for example shifting the table 46 on which the sign blank 5 is resting. Said shifting occurs in the X-Y-plane which preferably is parallel to the hot stamping foil 11 stretched over the table 46. More specifically, this relative positioning of the printed area of the hot stamping foil 11 and of the sign blank to be coated may be automated. The additionally printed orientation aids 31 may be utilized for automatization.

The printed hot stamping foil 11 is stretched over the sign blank 5 to be coated at a height of a few centimeters above the front side 52 of the sign blank 5.

To laminate the hot stamping foil 11 to the sign blank 5, the heated stamp roll 42 is brought in a first position 421 where it is lowered in such a way that the hot stamping foil 11 located between said roll and the front side 52 of the sign blank 5 contacts the front side 52 of the sign blank 5. Thereupon, the heated stamp roll 42 is shifted along the Y-axis into a second position 422, the speed at which the heated stamp roll 42 is shifted being adapted to the speed of the hot laminating process. The first and second positions 421 and 422 are selected so that, by shifting the heated stamp roll 42 between said two positions, the whole front side of the sign blank 5 to be coated is coated. The shifting of the lowered heated stamp roll 42 may be automated as well.

In an advantageous development of the method according to the invention, a protection sheet 44 is carried between the hot stamping foil 11 and the heated stamp roll 42 in the course of the lamination process. A polyester sheet, some ten micrometers thick is particularly suited to this effect. The surface of the hot-melt adhesive layer 12 as it originates from the hot stamping process carried out without protection sheet 44 surprisingly proved to have an increased optical backscatter. Said backscatter may be considerably reduced by using the method mentioned and by utilizing a protection sheet 44.

To apply this advantageous development of the method, the lamination device 4 is provided with an additional device 43 for interlaying a protection sheet 44 which is devised to place a protection sheet 44 between the hot stamping foil 11 and the heated stamp roll 42 during the process of laminating. A possible embodiment of such a device is illustrated in FIG. 1. It consists of a feed roll 441 feeding a protection sheet 44, from which the protection sheet 44 is delivered and fed to the heated stamp roll 42. Said protection sheet 44 is conveyed by way of said heated stamp roll 42 to a winding-up station 442 where the used polyester sheet is wound up again. Preferably, the polyester sheet is conveyed through the heated stamp roll 42 at a speed accurately matching the speed at which the heated stamp roll 42 is rolled over the sign blank 5 to be coated. In an advantageous development of the device, an endless loop of protection sheet 44 revolving between two rolls and the heated stamp roll 42 may be utilized. The rotational speed of said loop is again preferably adapted to the speed at which the heated stamp roll 42 is rolled in the process of hot stamping.

In an advantageous development of the method, a laminate bonding the two materials together is employed instead of a separate hot stamping foil 11 and of a protection sheet 44, of a polyester sheet for example. As shown in FIG. 4, such a laminate is advantageous for printing, since it is easier to be printed on as a result of its increased thickness. In this way, the problems occurring in hot stamping and leading to an optically dull surface of the heat-sealing layer 12 may furthermore be avoided from the beginning. In such a development of the method, a separate device 43 for carrying a protection sheet 44 during the hot stamping procedure is no longer needed, which results in a technically simpler laminating device 4.

Printing of the method according to the invention and the printer of the device according to the invention may also be altered in such a way that, instead of using a heat transfer method, an electrostatic printing technique or an ink jet printing technique is employed. The common feature of all printing methods is that they may be carried out in colour or in black-and-white.

In another advantageous development of the method UV-stabilizing and/or UV-absorbing molecules are added to the heat-sealing layer 12 of the hot stamping foil 11. In this way the colored content of the images stamped from the heat-sealing layer 12 and the reflecting sheet 51 laminated to the sign blank 5 may be guarded from premature aging, in particular from fading due to intensive UV-radiation in open air.

In another advantageous variant of the method according to the invention the hot stamping foil 11 employed is given a multilayered structure. This multilayered structure above all includes further functional layers on the future surface of the heat-sealing layer. Said future surface may particularly be provided with an antidew or with an antigraffiti coating. Such a structure of the hot stamping foil 11 in layers may be realized in a particularly advantageous way when further functional layers are added to the previously described laminate-like structure of the hot stamping foil 11 with a protection sheet 44. Said further functional sheets are preferably arranged between the heat-sealing layer and the protection sheet 44, such as for example layers that facilitate a separation of the heat-sealing layer 12 from a carrier foil in the process of hot laminating.

The method according to the invention not only includes printing, but also stamping, more specifically hot stamping or hot laminating. The hot stamping foil is to be understood as a foil on the underside of which a mirror-inverted image is printed into the adhesive and which upon printing is calendered in a heated condition onto retroreflecting foils. The adhesive employed is a so-called heat activated adhesive. Alternatively, a pressure sensitive adhesive such as used for example on pressure sensitive adhesive labels like e.g., the vignette of Switzerland for the highway toll, may also be used.

A separate layer of protective lacquer may be omitted since the very hot stamping foil constitutes a protection against UV rays as a result of being printed from underneath. The UV absorbing molecules are preferably added to the hot stamping foil.

Backscatter is to be understood as the diffuse scattering of light occasioned by the roughened surface generated by hot calendering on the hot stamping foil. As a result, retroreflection of the traffic sign foil lying underneath is considerably impaired. This is prevented from occurring by placing a polyester sheet between the roll and the hot stamping foil. Said sheet smoothes the surface of the hot laminate.

claim 17 recites an alternative method with a liquid adhesive (humid adhesive) instead of hot-melt adhesive. Lamination to the reflecting foil of the sign may also be completed without hot stamping or hot rolling since the pressure sensitive adhesive is capable of being applied with pressure only and does not require additional heating. The hot stamping foil may then simply be replaced by a stamping foil.

In an alternative method the process of laminating can be conducted with a vacuum press instead of a roll or a stamp.

What is claimed is:

1. A method for printing of traffic signs, comprising the following process steps:
inputting a pattern in digitized form of a traffic sign to be created to a printer by reading the pattern with a reading device and transmitting said pattern to the printer;
providing a hot stamping foil, the hot stamping foil having a surface being coated with a hot-melt adhesive, and printing the stored pattern on said surface of the hot stamping foil by means of the printer;
providing a foil guide and conveying the printed hot stamping foil to a laminating device by means of said foil guide; and
providing a reflecting sheet and heat laminating in a process of heat laminating the printed hot stamping foil to said reflecting sheet by means of a laminating device.

2. The method according to claim 1, wherein the pattern is printed on the hot stamping foil by means of one of the following techniques: heat transfer technique, electrostatic printing technique or an ink jet printing technique, and printing in color and/or in black-and-white.

3. The method according to claim 1, wherein markers are printed on the hot stamping foil in the process of printing and said markers are used for an alignment of the reflecting sheet relative to the printed hot stamping foil.

4. The method according to claim 3, wherein the reflecting sheet is laminated to a front side of a sign blank and the alignment of the reflecting sheet relative to the printed hot stamping foil is performed by automated shifting of a table on which the reflecting sheet is resting during the process of laminating and which is movable essentially in the plane of the sign blank.

5. The method according to claim 20, wherein during the heat laminating process a protection sheet is placed between the hot stamping foil and the heated stamp(s) and/or heated stamp roll(s), said protection sheet being suitable for reducing optical roughening of the surface of the hot stamping foil in the course of laminating.

6. Method according to claim 20, wherein the sign blank has a length to be coated, and, prior to its lamination to the sign blank, the printed hot stamping foil is completely unfolded over said blank and is stretched over the length of the sign blank that has to be coated.

7. Device for printing of traffic signs comprising the following elements:
a printer suitable for printing on a on a surface of a hot stamping foil coated with a hot-melt adhesive;
an inputting device connected to the printer suitable for storing a pattern of a traffic sign to be printed on said hot stamping foil, the pattern being in digitized form;
a laminating device fitted for hot laminating on a point or over an area the printed hot stamping foil to a reflecting sheet, said laminating device comprising a heated stamp or a heated stamp roll; and
a foil guide fitted for guiding the printed hot stamping foil to the laminating device.

8. The device according to claim 7, wherein the printer or the reading device is connected to a computer fitted to create the pattern by means of an appropriated program.

9. The device according to claim 7, wherein the printer is a heat transfer printer.

10. The device according to claim 7, wherein the printer is a laser printer.

11. The device according to claim 7, wherein the printer is an ink jet printer.

12. The device according to claim 7, wherein the printer is fitted to produce colored and/or black-and-white prints.

13. The device according to claim 7, wherein the foil guide has a first portion and a second portion, said first portion of the foil guide being fitted to roll up the hot stamping foil upon completion of the printing procedure and said second portion of the foil guide being fitted to bring the rolled up printed hot stamping foil to the laminating device.

14. The device according to claim 7, wherein the laminating device is provided with a table on which the reflecting sheet, which is preferably laminated to a sign blank, is resting during the laminating process, said table being movable essentially in the plane of the reflecting sheet.

15. The device according to claim 7, wherein the laminating device includes a device for interlaying a protection sheet, said device for interlaying a protection sheet being fitted to insert a protection sheet between the hot stamping foil and the heated stamp or heated stamp roll during the laminating process.

16. The device according to claim 7, wherein the laminating device is provided with a stretching device which is fitted to stretch the printed hot stamping foil over the length of the sign blank that has to be coated prior to laminating said hot stamping foil to the sign blank.

17. Method for printing of traffic signs, comprising the following process steps:
inputting a pattern in digitized form of a traffic sign to be created to a printer by reading the pattern with a reading device and transmitting said pattern to the printer;
providing a stamping foil, the stamping foil having a surface being coated with a pressure sensitive adhesive, and printing the stored pattern on said surface of the stamping foil by means of the printer;
providing a foil guide and conveying the printed stamping foil to a laminating device by means of said foil guide; and
providing a reflecting sheet and pressing in a process of pressure application the printed stamping foil to said reflecting sheet by means of a laminating device.

18. The method according to claim 1, wherein the laminating process is performed in a vacuum press.

19. The method according to claim 1, wherein the heat laminating process is performed by means of a heated stamp or a heated stamp roll either pointwise or areawise.

20. The method according to claim 1, wherein the reflecting sheet is laminated to a front side of a sign blank prior to heat laminating the printed hot stamping foil to said reflecting sheet.

21. The method according to claim 1, wherein the stored pattern is printed on said surface of the hot stamping foil by means of the printer in a mirror-inverted way.
